(19) United States
(12) Patent Application Publication
(10) Pub. No.: US 2014/0338166 A1
(43) Pub. Date: Nov. 20, 2014

(54) DOWEL PIN REMOVER TOOL

(71) Applicant: Electro-Motive Diesel, Inc., La Grange, IL (US)

(72) Inventor: Michael J. Studney, Chicago, IL (US)

(73) Assignee: Electro-Motive Diesel, Inc., La Grange, IL (US)

(21) Appl. No.: 14/449,257

(22) Filed: Aug. 1, 2014

(51) Int. Cl. B25B 27/02

(52) U.S. Cl. CPC B25B 27/023
USPC 29/256

(57) ABSTRACT

In one aspect of the present disclosure, a tool for removing a dowel pin from a component is shown. The tool includes an elongated nut, a bolt, a hollow pipe, at least one washer, and a fastening nut. The elongated nut has a first end and a second end. The first end has a threaded portion to receive the dowel pin. The bolt has a threaded first end and threaded second end. The bolt threaded first end is configured to be threaded into the second end of the elongated nut. A hollow pipe is positionable to cover the elongated nut and the bolt such that the first end of the hollow pipe is positioned around the dowel pin and a portion of the bolt extends outward beyond the second end of the hollow pipe. At least one washer is disposed through a bolt to make contact with the second end of the hollow pipe. A fastening nut is engaged to thread onto the second end of the bolt and is configured to apply pressure to the at least one washer, thereby extracting the dowel pin.

### TECHNICAL FIELD

The present disclosure relates generally to a tool, and more particularly, to a tool for removing dowel pins from components.

### BACKGROUND

Generally, tools may be used for installing or removing various components in service. However, over time, some components such as alternators or generators may become more affixed to their mounting surfaces than desired. As an example, within locomotives, some components are exposed to certain elements such as corrosion, rust, extreme weather and locomotive operating conditions and chemicals, such as diesel fuel during the course of traveling under varying locations and weather conditions. Thus, such locomotive components may become difficult to remove from such surfaces.

Removing components attached to mounting surfaces with dowel pins, requires the need of a tool to effectively remove the dowel pins. Ease of use of the tool is also needed, such that components may be easily removed within a confined space so that the dowel pins may be reused.

U.S. patent application Ser. No. 3,584,365 by Cuen, et. al. discloses an extractor device. The extractor device includes an elongated sleeve, wherein the sleeve has a first end and second end. An axially extending bore opens through said first end of the sleeve while opening in the second end of the sleeve permits a member to pass from the bore in the direction of the said second end of the sleeve.

While this tool may be capable of extracting a dowel pin from a component that may be located in a confined space, the screw threads of the dowel pins may be destroyed. Thus, the dowel pins may not be reused.

The present disclosure is directed to overcoming one or more problems set forth above and/or problems of the prior art.

### SUMMARY OF THE DISCLOSURE

In one aspect of the present disclosure, a tool for removing dowel pins from components is disclosed. The tool includes an elongated nut having a first end and a second end. The first end has a threaded portion to receive the dowel pin. The tool also includes a bolt having a threaded first end and threaded second end. The bolt threaded first end is configured to be threaded into the second end of the elongated nut. Additionally, the tool includes a hollow pipe having a first end and second end. The hollow pipe is positionable to cover the elongated nut and the bolt such that the first end of the hollow pipe is positioned around the dowel pin and a portion of the bolt extends outward beyond the second end of the hollow pipe. Further, the tool includes at least one washer disposed through a bolt to make contact with the second end of the hollow pipe. A fastening nut is engaged to thread onto the second end of the bolt and is configured to apply pressure to the at least one washer, thereby extracting the dowel pin.

Other features and aspects of this disclosure will be apparent from the following description and the accompanying drawings.

### BRIEF DESCRIPTION OF THE DRAWINGS

FIG. 1 is an exploded illustration of a tool that may be used for removing a dowel pin from a component, according to one embodiment of the present disclosure;

FIG. 2 is a parts illustration of an exemplary tool that may be used for removing a dowel pin from a component, according to one embodiment of the present disclosure; and

FIG. 3 is a final assembly illustration of an exemplary tool that may be used for removing a dowel pin from a component, according to one embodiment of the present disclosure.

### DETAILED DESCRIPTION

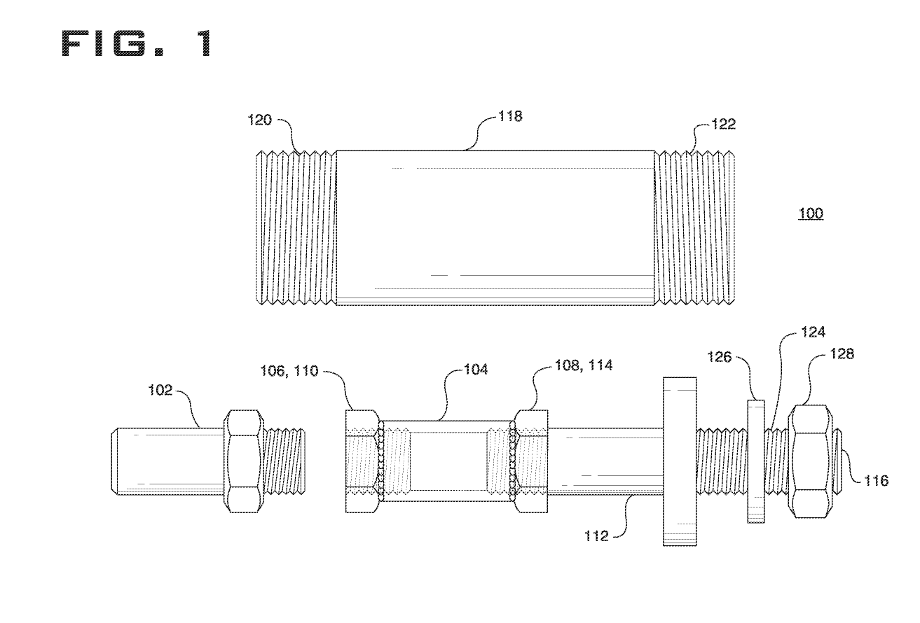

FIG. 1 is an exploded illustration of a tool 100 for removing a dowel pin 102 (not shown) from a component. The tool 100 includes an elongated nut 104, a bolt 112, a hollow pipe 118, at least one washer 126, and a fastening nut 128.

The elongated nut 104 has a first end 106 and second end 108. The first end 106 has a threaded portion 110 to receive the dowel pin 102. The elongated nut 104 may be made of steel, some other metal, plastic, or the like. The elongated nut 104 may consist of a singular or a plurality of pieces welded together.

The bolt 112 has a threaded first end 114 and a threaded second end 116. The threaded first end 114 of the bolt 112 is configured to be threaded into the second end 108 of the elongated nut 104. Such bolt 112 may be designed to engage with the elongated nut 104. In an embodiment, the bolt 112 may be configured to lock the bolt 112 in place, so that it does not move. In another embodiment, the bolt 112 may be configured to be partially or fully threaded distally along its length.

The hollow pipe 118 has a first end 120 and a second end 122. The hollow pipe 118 may be positioned to cover the elongated nut 104 and the bolt 112 such that the first end 120 of the hollow pipe 118 is positioned around the dowel pin 102. A portion of the bolt 124 may be configured to extend outward beyond the second end 122 of the hollow pipe 118.

The at least one washer 126 may be disposed through the bolt 112 to make contact with the second end 122 of the hollow pipe 118. The washer 126 may be configured as a thin plate with a hole (typically in the middle) to distribute the load resulting from the threaded fastening nut 128. The washer 126 may be made of suitable metal or plastic material that can efficiently distribute the load that results from the threaded fastening nut 128.

The fastening nut 128 may be engaged to thread onto the second end 116 of the bolt 112. The fastening nut 128 may be configured to apply pressure to the at least one washer 126 to thereby extract the dowel pin 102.

### INDUSTRIAL APPLICABILITY

An example of operation of the dowel pin remover tool 100, railroads may use tools for installing or removing various locomotive components in service. However, over time, some components such as alternators or generators may become more affixed to their mounting surfaces than desired within the locomotive because they are exposed to certain elements such as corrosion, rust, extreme weather and locomotive operating conditions and chemicals. Thus, removal of these components tends to be difficult. For example, in some case, the dowel pin may become stuck in a hole used to affix the dowel pin to the component mounting surface. If this occurs, the component should not be extracted with the dowel pin stuck in the hole. This may damage or elongate the hole and damage threads on a dowel pin, thus preventing reuse. Such a dowel pin requires a press fit in order to maintain alignment. Thus, there is a need for a tool that is capable of extracting dowel pins from the component without damaging its screw threads so that the dowel pins may be reused.

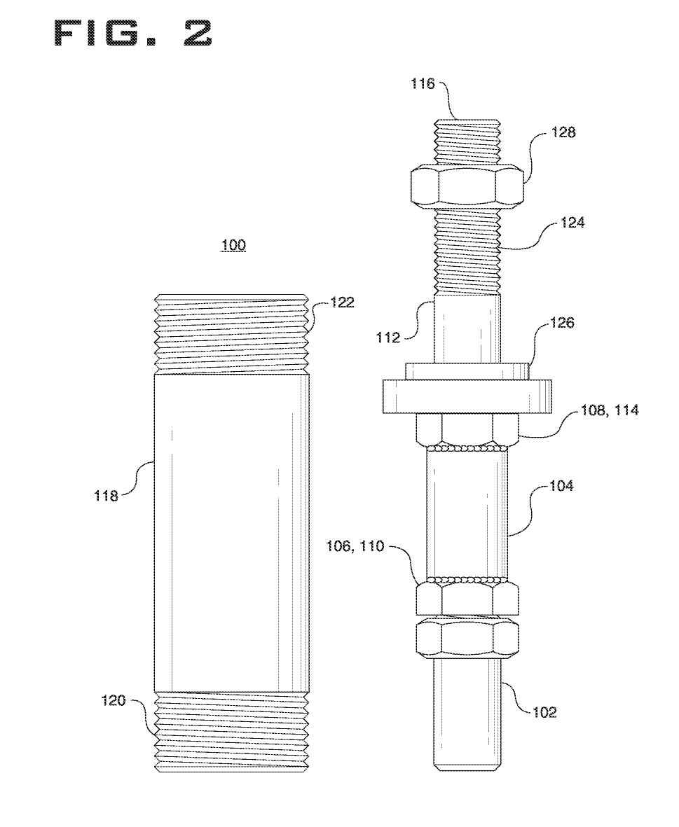

In the present disclosure, FIG. 2 illustrates a partially assembled exemplary tool 100 that may be used for removing a dowel pin 102 from a component, according to one embodiment of the present disclosure. Herein, the elongated nut 104 is engaged to receive the dowel pin 102. Also, the washer 126 and the fastening nut 128 are disposed in positions through the bolt 112. In full operation, the washer 126 and the fastening nut 128 are temporarily removed so the hollow pipe 118 is inserted through the bolt 112 to cover the elongated nut 104 and the dowel pin 102.

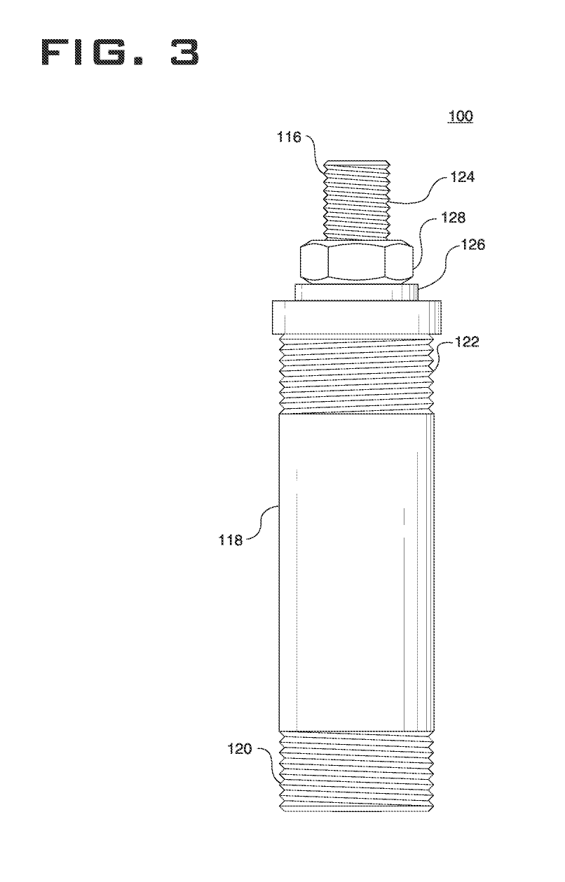

FIG. 3 illustrates the finally assembled exemplary tool 100 that may be used for removing a dowel pin 102 from a component, according to one embodiment of the present disclosure. As shown, the hollow pipe 118 is positioned to cover the elongated nut 104 and the bolt 112 such that the first end 120 of the hollow pipe 118 is positioned around the dowel pin 102 and a portion of the bolt 124 extends outward beyond the second end 122 of the hollow pipe 118. Thus, when the fastening nut 128 is engaged to thread on to the second end 116 of the bolt 112 and pressure is applied to the washer 126, the dowel pin 102 is extracted.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A tool for removing a dowel pin comprising:
an elongated nut having a first end and second end, the first end having a threaded portion to receive the dowel pin;
a bolt having a threaded first end and a threaded second end, the bolt threaded first end configured to be threaded into the second end of the elongated nut;
a hollow pipe having a first end and a second end, the hollow pipe being positionable to cover the elongated nut and the bolt such that the first end of the hollow pipe is positioned around the dowel pin and a portion of the bolt extends outward beyond the second end of the hollow pipe;
at least one washer disposed through the bolt to make contact with the second end of the hollow pipe and;
a fastening nut engaged to thread onto the second end of the bolt and configured to apply pressure to the at least one washer, thereby extracting the dowel pin.
